(19) United States
(12) Patent Application Publication
(10) Pub. No.: US 2025/0377368 A1
(43) Pub. Date: Dec. 11, 2025

(54) LABORATORY AUTOMATION DEVICES AND RELATED SYSTEMS AND METHODS

(71) Applicant: LIFE TECHNOLOGIES CORPORATION, Carlsbad, CA (US)

(72) Inventors: Keith McKinley, Brier, WA (US); William Michael LAFFERTY, Encinitas, CA (US); C. Alan PEET, Kent, WA (US); Andrew WEBER, Lake Forest Park, WA (US); James Edward DASCHEL, Eugene, OR (US); Ricardo NOYOLA LOZANO, Shoreline, WA (US); Godfrey PADILLA, Everett, WA (US)

(21) Appl. No.: 19/124,863

(22) PCT Filed: Oct. 26, 2023
(86) PCT No.: PCT/US2023/077836

§ 371 Date: Apr. 26, 2025

Related U.S. Application Data
(60) Provisional application No. 63/381,114, filed on Oct. 26, 2022.

(51) Int. Cl. G01N 35/00; G01N 35/10

(52) U.S. Cl. CPC G01N 35/0099; G01N 35/10

(57) ABSTRACT

A system for robotic laboratory operations includes a stationary surface (2) adjacent laboratory equipment and at least one mover (4) configured to perform an action upon a payload atop the stationary surface (2). The action includes but is not limited to translation across at least a portion of the stationary surface. The at least one mover (4) has a drive member (12) configured to drive the translation a carrier that is mounted to the drive member and has a top surface configured to carry a pay load (8). The drive member (12) is configured to drive the at least one mover (4) across the at least the portion of the stationary surface (2) for moving the payload relative to the laboratory equipment.

### TECHNICAL FIELD

The present invention relates to devices and methods for performing laboratory operations, and more particularly to autonomous movers for operating labware atop a working surface to perform various laboratory operations.

### BACKGROUND

Various types of experiments and/or tests utilizing liquid samples are performed in life science laboratories, such as antibody testing, genetic analysis, drug screening, cell therapy experiments, protein analysis, and/or others. Pursuant to such experiments, liquid samples are typically transferred among different vessels and/or substrates of various types and/or volumes. The number of transfers required for such experiments can be formidable in certain conditions, such as when investigating multiple combinatorial conditions. In such circumstances, liquid handling by hand can be tedious, difficult, and/or prone to human error.

This challenge has given rise to liquid handling robot (LHR) technologies, where programmable, sensor-integrated robotic systems are utilized to automate liquid handling processes associated with liquid samples. Conventional LHR systems typically utilize a pipettor or gripper attached to a robotic arm or gantry configured for 3-axis movement to move the pipettor or gripper to various labware components to facilitate liquid handling tasks.

However, existing LHR systems suffer from a number of shortcomings. Accordingly, there is an ongoing need and desire in the field for improved systems and methods for facilitating automated lab operations.

### SUMMARY

According to an embodiment of the present disclosure, a system for robotic laboratory operations includes a stationary surface adjacent laboratory equipment. The at least one mover has a drive member configured to drive the translation a carrier that is mounted to the drive member and has a top surface configured to carry the payload. The drive member is configured to drive the at least one mover across the at least the portion of the stationary surface for moving the payload relative to the laboratory equipment.

According to another embodiment of the present disclosure, a method includes operating a first mover configured for motion atop a stationary surface. The operating step is performed to change the position of the first mover relative to the stationary surface and thereby moves a sample carried by the first mover into or out of engagement with labware and/or lab components positioned atop or adjacent the stationary surface.

According to an additional embodiment of the present disclosure, a method includes operating a first mover configured for motion atop a stationary surface. The operating step is performed to change a material property of a sample while moving a second mover that carries labware relative to the stationary surface.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the features of the present application, there is shown in the drawings illustrative embodiments. It should be understood, however, that the application is not limited to the precise arrangements and instrumentalities shown. In the drawings:

FIG. 1A is a perspective view of an illustrative laboratory system for performing parallel lab operations atop a working surface, according to an embodiment of the present disclosure;

FIG. 1B is a perspective view of another example of a laboratory system, similar to the system shown in FIG. 1A, showing the inclusion of an expanded modular working surface, according to an embodiment of the present disclosure;

FIGS. 2A-2B are side plan views of movers carrying labware for lab operations within the laboratory systems illustrated in FIGS. 1A-1B;

FIG. 3A is a side plan view of a mover illustrated in FIGS. 2A-2B, wherein the mover employs a magnetic levitation drive system, according to an embodiment of the present disclosure;

FIG. 3B is a top plan view of an exemplary mover, according to an embodiment of the present disclosure;

FIG. 3C is a perspective view of the mover illustrated in FIG. 3B, shown carrying a payload for use in the laboratory system illustrated in FIGS. 1A-1B, according to an embodiment of the present disclosure;

FIG. 3D is a perspective view of various types of illustrative labware carried by movers of the present disclosure;

FIG. 3B is a perspective view of an exemplary drive member of a mover, showing the axes of motion of the drive member, according to an embodiment of the present disclosure;

FIG. 4 is a side plan view demonstrating an example shaking motion performable by a mover and the labware carried thereby for a lab operation, according to an embodiment of the present disclosure;

FIG. 5 is a side plan view demonstrating an example stirring motion performable by a mover and the labware carried thereby for a lab operation, according to an embodiment of the present disclosure;

FIG. 6 is a side plan view demonstrating an example tilting motion performable by a mover upon its payload for a lab operation, according to an embodiment of the present disclosure;

FIG. 7 is a perspective view demonstrating an example pitch/roll motion performable by a mover to avoid spilling fluid samples while executing a sharp turn atop the working surface, according to an embodiment of the present disclosure:

FIG. 8 is a side plan view demonstrating an example tapping motion performable by a mover upon its payload for a lab operation, according to an embodiment of the present disclosure;

FIG. 9 is a side plan view demonstrating an example pressing motion performable by a mover upon its payload for a lab operation, according to an embodiment of the present disclosure;

FIG. 10 is a side plan view of a mover having an actuatable element for affecting material properties of a fluid sample, according to an embodiment of the present disclosure;

FIG. 11 is a perspective view of a mover carrying an actuatable laboratory tool, according to an embodiment of the present disclosure;

FIG. 12 is a perspective view of an auxiliary area for storing movers and labware adjacent the working surface of a laboratory system, according to an embodiment of the present disclosure;

FIG. 13A is a perspective view of an exemplary eccentric mover configured for carrying a payload offset from a geometric center of the drive member;

FIG. 13B is a perspective view of the eccentric mover illustrated in FIG. 13A, shown positioning a payload in proximity to an offboard lab tool; and

FIGS. 14A-14B are diagrams showing example methods for performing laboratory operations, according to embodiments of the present disclosure.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used in the specification including the appended claims, the singular forms “a.” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The terms “approximately”. “about”, and “substantially”, as used herein with respect to dimensions, angles, ratios, and other geometries, takes into account manufacturing tolerances. Further, the terms “approximately”, “about”, and “substantially” can include 10% greater than or less than the stated dimension, ratio, or angle. Further, the terms “approximately”. “about”, and “substantially” can equally apply to the specific value stated.

It should be understood that, although the terms first, second, third, and the like can be used herein to describe various elements, these elements should not be limited by these terms. These terms are instead used to distinguish one element from another. For example, a first element could be termed a second element, and, similarly, a second element could be termed a first element in another context, without departing from the scope of the embodiments disclosed herein.

Implementations of the present disclosure extend at least to laboratory automation that moves one or more labware components relative to a laboratory workstation.

The embodiments disclosed herein pertain to robotic devices and systems that move and activate components at the laboratory workstation for laboratory operations. The actions of the robotic movers described herein, including their motions and other actuations, are highly controllable for accurate, customizable parallel laboratory operations.

For brevity, both the singular and plural versions of the term “labware component” can also be referred to herein as “labware.”

The disclosed embodiments can be implemented to address various shortcomings associated with at least some conventional LHR systems. As noted above, conventional LHR systems utilize robotic arms and/or gantries (movable in 3 axes) to facilitate movement of processing heads (e.g., pipettors, grippers) into communication with labware components (arranged at fixed positions) to perform liquid handling tasks. The use of robotic arms and/or gantries movable in 3 axes to facilitate liquid handling tasks severely limits the efficiency of conventional LHR systems. For example, such a system typically limits the number of processing heads that can simultaneously move into interaction with labware in view of the increased likelihood of collision or conflict posed by the use of multiple overhead robotic arms and/or gantries. Furthermore, while multiple processing heads can be affixed to a single robotic arm or gantry, the presence of multiple processing heads on the robotic arm or gantry may limit the reach of the robotic arm or gantry. Still furthermore, even where a robotic arm or gantry includes multiple processing heads, such components are only usable in parallel when the labware queued for interaction are positioned in suitable arrangements to permit parallelized interaction. All of these limitations make use of a gantry a significantly limiting basis for complex and multifaceted processes. By moving such activities, behaviors, and capabilities onto the mover itself, far more dynamic, configurable and efficient processes can be carried out.

In view of at least some of the foregoing constraints, conventional LHR systems utilize one robotic arm or gantry (or few) to facilitate movement of processing heads for performing liquid handling tasks. Some robotic arms or gantries are able to exchange processing heads to perform different lab processes. In view of this limitation, typical LHR systems focus their functionality on in-series performance of ubiquitous liquid handling tasks, such as pipetting and gripping. This results in significant idle time for processing heads and/or labware components that are not part of the current process being performed by the conventional LHR system. Furthermore, in view of the focus on pipetting and gripping, conventional LHR systems provide for limited customizability to enable automation of additional lab processes.

In contrast with conventional LHR systems, which implement 3-axis movement of a robotic arm or gantry to facilitate automation of liquid handling tasks, embodiments of the present disclosure utilize robotic movers for moving and actuating labware components themselves (e.g., liquid vessels and/or others) relative to processing heads of the system.

Embodiments that utilize robotic movers for moving and actuating labware relative to processing heads and other system components, in accordance with the present disclosure, can provide numerous advantages over conventional LHR systems. For example, disclosed embodiments can enable efficient performance of parallelized lab operations in a manner that is impossible under conventional LHR techniques. For instance, the robotic movers can arrange multiple labware components under multiple processing heads in preparation for lab operations to be performed thereon (e.g., pipetting, vessel transfer, etc.), and the first set of actuators can actuate multiple processing heads into engagement with the multiple labware components in parallel. The robotic movers can then proceed to move the processed labware components away from the processing heads and move a different set of multiple labware components under the processing heads in preparation for a subsequent lab operation. Such functionality can significantly reduce the idle time for processing heads and/or labware components and can greatly increase the speed and/or efficiency with which liquid handling tasks can be performed in laboratory environments.

As used herein, “parallel” or “parallelized” operations refer to separate operations (such as those performed by separate processing heads or separate mover-based activities) that are performed with any temporal overlap, such that any actions or sequences associated with performance of the separate operations are performed at the same time. In some instances, parallel lab operations comprise separate operations that are performed in synchrony (e.g., where multiple processing heads descend in the same direction simultaneously into engagement/interaction with labware components positioned thereunder, or where processing heads perform their tasks simultaneously, or where labware components are moved into position under processing heads simultaneously), whereas, in some instances, parallel lab operations comprise separate operations that are not performed in synchrony (e.g., where at least some aspects of actuation or task performance of processing heads and/or labware components occurs at the same time, but with different actions being performed, different rates of performance, different start times, different end times, different movement/rotation directions, different durations, etc.).

Because the disclosed systems can reduce dependence on multi-axis movement of a gantry or robotic arm over the labware components, the spatial footprint of the disclosed systems can be smaller than that of conventional LHR systems (while still matching or exceeding the performance of conventional LHR systems). Moreover, because multi-axis movement of the processing heads is not necessarily required in the disclosed systems, the disclosed systems can include multiple types of processing heads in addition to, or as an alternative to, pipettors and/or grippers, and such processing heads can be configured to perform their respective operations at least partially in parallel (e.g., where at least two processing heads perform their respective functions in parallel).

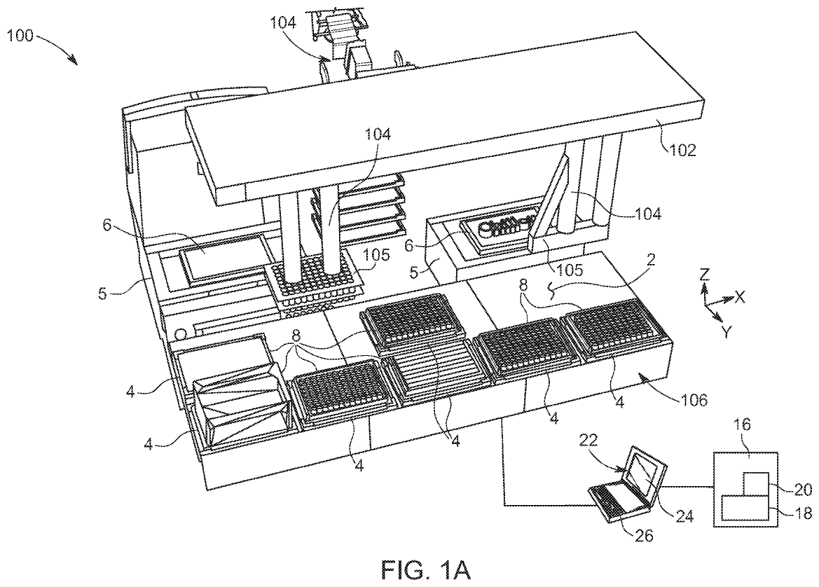

Referring to FIG. 1A, an example laboratory system 100 for facilitating mobile lab operations is shown that includes a work deck 1, one or more robotic movers 4 operable upon a stationary working surface 2 of the work deck 1, and one or more offboard lab components positioned adjacent the working surface 2. The movers 4 are configured to carry various payload components 8 upon the working surface 2 and perform one or more actions upon the payload 8 in autonomous or semi-autonomous fashion, as described in more detail below. The working surface 2 extends along a first or longitudinal direction X and along a second or lateral direction Y that is perpendicular to the longitudinal direction X. The longitudinal and lateral directions X, Y are perpendicular to a third or vertical direction Z. It should be appreciated that, as used herein: the terms “longitudinal”, “longitudinally”, and derivatives thereof refer to the longitudinal direction X; the terms “lateral”, “laterally”, and derivatives thereof refer to the lateral direction Y; and the terms “vertical”. “vertically”, and derivatives thereof refer to the vertical direction Z. It should also be appreciated that a plane extending along the longitudinal and lateral directions X. Y can be referred to herein as the “X-Y plane.” In the illustrated example, the working surface 2 is elongate along the longitudinal direction X, although in other embodiments the working surface 2 can be substantially equidistant along the first and second direction X, Y. Additionally, in the illustrated example, the working surface 2 is planer, although in other embodiments, the working surface 2 can have one or more non-planar portions, such as contoured portion(s). In yet other embodiments, the working surface 2 can have one or more inclined portions, such as one or more ramp portions or even one or more vertical portions.

The offboard lab components include offboard labware 6, such as various types of fluid vessels usable in lab operations, such as tubes, beakers, flasks, reservoirs, troughs, well plates, cell-culture dishes, slides, washing/cleaning solution reservoirs, priming solution reservoirs, and/or others; aside from fluid vessels, additional offboard labware 6 can include slide holders, tube holders, waste containers, bead holders, and/or others, by way of non-limiting examples.

The offboard lab components also include various lab tools 5, which can include liquid vessels, pipettors, grippers, containers, sensors, thermal cyclers (also referred to herein as “thermocyclers”), heating elements, cooling elements, mixers, centrifuges, and the like, by way of non-limiting examples. The laboratory system 100 also preferably includes structure for supporting, actuating, and operating the offboard tools 5, including such structure as gantries, robot arms, processing heads, and the like. As shown in FIG. 1A, the exemplary laboratory system 100 includes a gantry 102 carrying offboard actuators 104 for moving offboard tools 5, including processing heads 105, relative to the working surface 2 at least in the vertical direction Z and preferably also in the longitudinal and lateral directions X, Y. The laboratory system 100 can include one or more additional offboard actuators 104 for moving additional offboard tools 5 relative to the working surface 2.

The processing heads 105 illustrated in FIG. 1A include a 96-magnet bead, such as that produced under the KingFisher® Apex and/or Flex brand of processing heads by Thermo Fisher Scientific Inc., of Waltham, Massachusetts, USA, (left) and a 12-channel pipette (right). However, additional or alternative processing heads 105 are within the scope of the present disclosure, such as, by way of non-limiting example, other types of pipettors (e.g., single-channel or multi-channel such as 8-channel, 12-channel, 16-channel, 24-channel, 96-channel, 384-channel, 1536-channel, n-channel: with any capacity/capacities such as 250-500 μL, 1 mL, 5 mL, etc.; and/or with any type(s) of tips such as filtered tips, wide-bore tips, clear tips, liquid detection tips (conductive tips, pressure-based tips), magnetic application tips, etc.), grippers (e.g., single grippers, multi-grippers, rotatable grippers), dispensers (e.g., peristaltic or diaphragm-based dispensers), well washing devices, plate sealers, seal peelers, colony pickers, tube cappers/decappers, tube pickers, magnetic bead collection/transfer components, pin tools, pneumatic devices, hydraulic devices, fluidic devices (e.g., pipettes, pumps (e.g., syringe pumps, peristaltic pumps, diaphragm pumps), quick-connects for filling/draining when connected), and optical devices. Thus, the processing heads 105 can be usable to facilitate a wide variety of lab operations, which can be performed in parallel (e.g., when appropriate labware components are arranged thereunder via the movers 4). Such lab operations can include, by way of non-limiting example, single aspiration, serial aspiration, single dispensation, serial dispensation, tip changing, tip mixing, cherry picking, labware transfer, well washing, plate sealing, seal penetration or removal, colony picking, tube capping or de-capping, tube transfer, magnetic bead manipulation, sonification, inspection/detection (e.g., visual or other modes), payload movement (via grippers or other manipulators), label application and/or scanning (e.g., barcode application and/or scanning), lid application and/or removal, electroporation, and/or others, by way of non-limiting examples. The processing heads 105 can be plumbed to one or more fluid sources to facilitate their respective functions (e.g., plumbed to a priming solution source, washing solution source, vacuum/air source, etc.). The payload 8 can include various types of fluid vessels usable in lab operations, such as tubes, beakers, flasks, reservoirs, troughs, well plates, cell-culture dishes, slides, washing/cleaning solution reservoirs, priming solution reservoirs, and/or others, by way of non-limiting example. Other types of payload 8, aside from fluid vessels, are also within the scope of the present disclosure, such as slide holders, tube holders, waste containers, bead holders, and/or others, by way of non-limiting examples.

As mentioned above, the movers 4 are configured to perform one or more actions upon the payload 8 for conducting laboratory operations. Such action can include dynamic operations, such as moving the payload 8 relative to the working surface 2 according to one or more modes of motion, such as translation, rotation, vibration, and rapid iterative motions (e.g., tapping), by way of non-limiting examples. For instance, translation may include translation across at least a portion of the stationary surface. The stationary surface over which the labware components may translate in the x direction, and/or the y direction, and/or the z direction. Such a surface may comprise multiple zones associated with operation of the system 100 within a lab environment.

Additionally or alternatively, the one or more actions performable by the movers 4 can include static operations, such as heating, cooling, imaging, scanning, sensing, measuring, onboard tool operations, or other actions relating to affecting samples within the payload 8. As used herein with reference to action(s) performed upon a payload 8, the term “static” and derivatives thereof refer to actions that do not require relative motion of the payload 8 relative to the working surface 2 to complete such action(s). It should be appreciated, however, that unless stated otherwise, the static action(s) described herein can be capable of being performed concurrently while the associated payload 8 moves relative to the working surface 2. Accordingly, in some embodiments, the movers 4 can also be configured to move the payload 8 while also performing one or more static operations on the payload 8. One such example includes a mover 4 translating liquid samples disposed in labware of a payload 8 while also measuring the temperature of the samples using a thermocouple of the payload 8. Thus, the movers 4 of the present disclosure can be configured to perform numerous laboratory operations upon the working surface 2, including performing operations simultaneously with the operations of other movers 4 and/or the operations of other labware (e.g., onboard and/or offboard) for parallel lab operations. It should also be appreciated that the movers 4 can perform laboratory operations independently (e.g., independent of the offboard components and/or other movers 4).

The movers 4 can have a power storage device (such as a lithium-ion battery, by way of a non-limiting example) to facilitate static and/or dynamic actions while in motion. In additional embodiments, the movers 4 can include one or more ports for communicating various medium(s) onto and/or from the movers 4. For example, the movers 4 can include one or more ports for power communication, fluidic/hydraulic/pneumatic communication, and/or for docking with one or more additional elements on the work deck 1 and/or on the processing heads 105.

The laboratory system 100 includes a control unit 16 in communication with the movers 4, the payloads 8, and the offboard components for controlling laboratory operations. The control unit 16 includes a processor 18 configured to execute computer readable instructions stored in computer memory 20. The control unit 16 can also be adapted to receive input from a human operator at a computer station 22, which can include a user interface for presenting and receiving information from a user. For example, the computer station 22 can include a display 24, such as a monitor, for presenting information to the operator, and inputs 26, such as buttons and/or a keyboard, allowing the user to affect operation of the movers 4, the payload 8, the offboard components as needed. It should be appreciated that various computerized systems and components (including hardware and software) can be employed to facilitate programmed operations of the system 100 and its components.

It should be appreciated that various features of the laboratory system 100 can be adapted for modular assembly. For example, referring now to FIG. 1B, the work deck 1 can comprise an assembly of deck modules 1a arranged together, each defining a working surface 2a, which collectively define a modular working surface 2. In this manner, the modularity of the work deck 1 and working surface 2 allow for expansion and reduction of the area for laboratory operations (and the amount of available offboard components that can use the area in parallel) as needed.

It should further be appreciated that the modular assembly discussed above can be designed such that the modular working surface 2 can be installed as an extension to an existing instrument and can be added along with a new gantry to extend the existing gantry 102 that carries offboard actuator(s) 104. This added gantry can add new and/or additional processing heads, which can be of the same function as other processing heads or can add other functionality. The system 100 that includes such new and/or additional processing heads can be controlled by control unit 16 for fully integrated and parallelizable control.

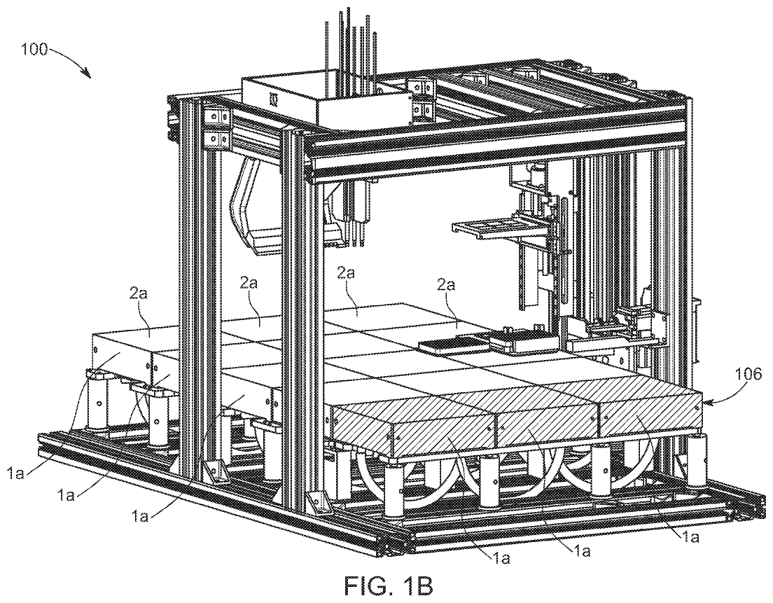

Referring now to FIGS. 2A-2B, an example of a pair of movers 4a, b performing dynamic operations is shown. In this example, a first mover 4a and a second mover 4b each carry a payload 8 that includes tubes within tube holders. The first mover 4a is configured to move in controlled fashion along the longitudinal and lateral directions X, Y to position its payload 8a at a first predetermined position for interaction with a first processing head 105a (in the form of a gripper), which is actuated by a first offboard actuator 104a, which in this example is carried by a gantry 102. The second mover 4b is configured to move in controlled fashion along the longitudinal and lateral directions X. Y to position its payload 8b at a second predetermined position for interaction with a second processing head 105b (in the form of a multi-channel pipettor), which is actuated by a second offboard actuator 104b, which is also carried by the gantry 102. With the first and second movers 4a,b at their respective predetermined positions, the first and second offboard actuators 104a,b can move their respective processing heads 105a,b into engagement with the associated payload 8a,b. In this example, the offboard actuators 104a,b each move their processing head 105a,b into and out of engagement with the payload 8a,b via translation along the vertical direction Z. It should be appreciated that one or both of the first and second processing heads 105a,b can also be moved in controlled fashion along the longitudinal and lateral directions X, Y, such as be one or more additional actuators, which can be carried by the gantry 102.

For example, in some embodiments, at least one mover 4 can be configured to perform one or more laboratory operations upon payload 8 independently. e.g., without the assistance of the offboard components or other movers 4. In other embodiments, at least one mover 4 can be configured to interact with offboard components), for joint onboard-offboard laboratory operation(s). In additional embodiments, at least one mover 4 can be configured to perform laboratory operations via interaction with at least one other mover 4 or the payload 8 thereof, for joint payload-payload laboratory operation(s). In further embodiments, at least one mover 4 can be configured to perform laboratory operations via interaction with offboard component(s) and with at least one other mover 4 or the payload 8 thereof. In further embodiments, at least one mover 4 can be configured to perform operations via interaction with static or active offboard components on the perimeter of the work deck 1 to facilitate auxiliary activities. Examples of various actions performable by the movers 4 will be described in more detail below.

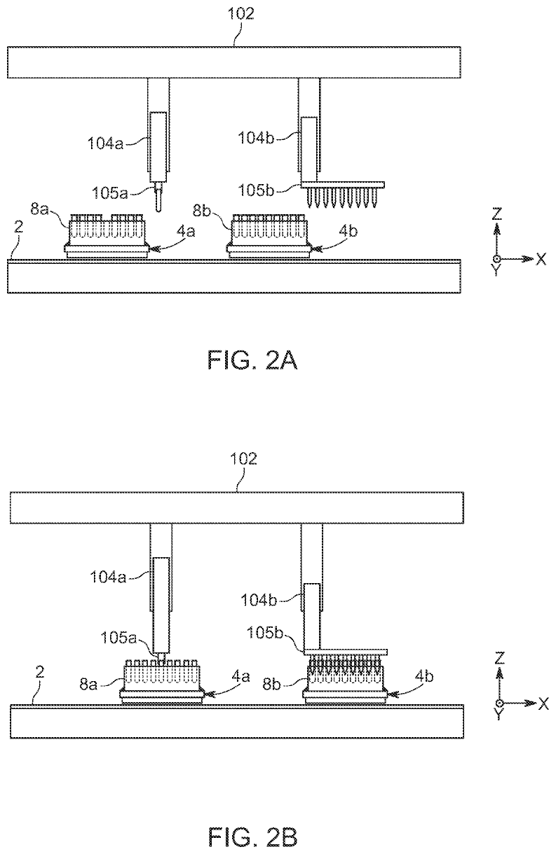

Referring now to FIGS. 3A-3E, exemplary movers 4 of the system 100 each include a drive member 12 for driving motion of the mover 4 and a carrier 14 for carrying the payload 8. In the illustrated embodiments herein, the drive member 12 is configured to translate the mover 4 and its payload 8 at least along the longitudinal and lateral directions X, Y and optionally also along the vertical direction Z. In the illustrated embodiment of the movers 4, the laboratory system 100 includes a magnetic levitation system for providing precise motion control of the drive members 12 of the movers 4, and thereby also moving the carrier 14 and the payload 8 carried thereby. Although the following description pertains to embodiments where the drive members 12 are incorporated within a magnetic levitation system, it should be appreciated that the system 100 can employ drive members 12 that incorporate other types of drive systems for providing precise motion control of the movers 4, such as types utilizing rollers, wheels, and/or other drive means for translating the movers 4 along the working surface 2.

The carrier 14 is mountable to the drive member 12. Preferably, the drive member 12 is configured to mount interchangeably with a variety of carriers 14 having various geometries, shapes, and/or configurations. The drive member 12 preferable includes mounting structures that engage with complimentary mounting structures of the carrier 14 and/or mounting fasteners. In the illustrated embodiment, the drive member 12 includes a drive body 30 defining a top surface 32 and a plurality of mounting holes 34, as shown in FIG. 3E. As shown in FIG. 3B, the carrier 14 has a carrier body 36 that defines mounting holes 38, such that at least some of the mounting holes 38 of the carrier 14 align with at least corresponding ones of the mounting holes 34 of the drive member 12. The aligned mounting holes 34, 38 are configured to receive locking members, such as locking screws or pins 39, that attach the carrier body 36 to the drive body 30. It should be appreciated that various other types of mounting and locking structures for attaching the carrier 14 to the drive member 12 are within the scope of the present disclosure. When attached to the drive member 12, the carrier 14 is preferably capable of maintaining attachment with the drive member 12 when a vertical or horizontal force differential of at least about 10 Newtons (N) is applied between the drive member 12 and carrier 14.

The carrier 14 is configured to carry a payload 8 in secure fashion. As shown, the carrier body 36 can have a tray-like geometry that defines a receptacle 40 having a support surface 42 for holding or otherwise supporting a payload 8. The carrier body 36 can also include one or more peripheral rim members 44 spaced peripherally around the support surface 42. The one or more peripheral rim members 44 can be configured to abut or otherwise support sides and/or edges of the payload 8. The carrier 14 also preferably includes grip features 46 for securely holding the payload 8 to the carrier body 36. As shown, the grip features 46 can include clasps 46 or other features for securely engaging the payload 8. The grip features 46 can be configured to provide a gripping force that optionally biases the payload 8 toward the center of the support surface 42. In other embodiments, the clasps 46 can be snap-fit type clasps that lock into engagement with complimentary recesses defined in the sidewalls of the payload 8. In such embodiments, the payload 8 can be coupled to the carrier body 36 by pressing the payload toward the support surface 42 until the snap-fit clasps click into place.

The carrier body 36 and the receptacle 40 and support surface 42 thereof can be sized to hold a payload 8 having common and/or standardized dimensions, such as those standardized according to the Society for Biomolecular Screening (SBS). In this manner, the carriers 14 can interchangeably carry a wide variety of labware components. The carrier body 36 can be constructed using rapid manufacturing processes, such as, but not limited to, a 3D-printing processes, a milling process (such as from aluminum), or a casting or molding process (such as from metal or plastic), by way of non-limiting examples. In this manner, the carriers 14 can be rapidly produced having different sizes and configurations for holding various types of labware, as needed. Preferably, the carriers 14 employ generally simple geometries, thereby allowing for inexpensive replacement should a carrier 14 break or degrade outside acceptable lab parameters.

Referring now to FIG. 3D, the movers 4 of the present disclosure can be configured to carry various types of payloads. As shown, the payload 8 can include a 384-well PCR microplate 8c, a 96-well PCR microplate 8d, other microplates 8e, a tip box with tips 8f, multi-trough vessels 8g, and waste containers 8h, by way of non-limiting examples. The carriers 14 can be configured to carry various other types of payloads 8, including but not limited to open reservoirs, cell culture plates, petri dishes, slides, beakers, flasks, tube racks, tools (e.g., grippers and other manipulators), dump-containers, sensors, cameras, scanners, and the like. The carriers 14 can also be configured to hold various types of support components 48 for supporting and/or stabilizing a payload 8. Such support components 48 can be configured, for example, as support spacers for payloads 8 having a cross-sectional area that is smaller than that of the support surface 42. Such support components 48 can be configured to provide horizontal support for payloads 8 having increased height. Additionally or alternatively, the support components 48 can be configured to hold the payload 8 with a gap provided below the payload 8 to facilitate offboard robotic interaction which requires bottom-contact for lifting and lowering of payload 8. It should be appreciated that the scope of the payload 8 and supporting components 48 that can be carried by the carriers 14 of the present disclosure are not limited to those examples listed above.

The magnetic levitation system can comprise a stator unit 106 (FIGS. 1A-1B) provided by the work deck 1. The stator unit 106 includes a magnetic coil matrix 108 (FIG. 3A) that is positioned beneath the working surface 2 and is controllable to cause levitation of the drive member 12 (and the carrier 14 and payload 8 thereon). The drive member 12 can include one or more permanent magnets for levitating the drive member 12 (and the carrier 14 and payload 8 thereon) above the working surface 2 when interacting with the magnetic field generated by the coil matrix 108.

The drive member 12 of this example also includes one or more magnetically responsive units (MRUs) that interact with the magnetic field generated by the magnetic coil matrix 108 for providing controlled operation of the drive member 12. For example, the drive member 12 can include a first MRU for controllably moving the drive member 12, such as for translating the drive member 12 along the longitudinal and lateral direction X, Y. and also for raising and lowering the drive member 12 relative to the working surface 2 along the vertical direction Z. The drive member 12 can also include a second MRU for bidirectional transfer of power and/or information, such as for facilitating precise controlled movement of the drive member 12 via the first MRU.

By way of a non-limiting example, the stator unit 106 and the movers 4 of the illustrated embodiment can be of the type(s) produced by Planar Motors Inc . . . of Richmond, British Columbia, Canada. The magnetic levitation system can be constructed and operated as more fully described in U.S. Pat. No. 10,926,418, issued Feb. 23, 2021, in the name of Lu et al. (hereinafter “the '418 Reference”) U.S. Patent Publication No. 2021/0376777 A1, published Dec. 2, 2021, in the name of Lu et al. (hereinafter “the '777 Reference”), and U.S. Patent Publication No. 2022/0212883 A1, published Jul. 7, 2022, in the name of Lu et al. (hereinafter “the '883 Reference”), the entire disclosure of each of which is incorporated herein by this reference and are each included as part of the present disclosure.

Referring now to FIG. 3E, the drive members 12 preferably provide a wide range of motion relative to the working surface 2. In the illustrated example, each drive member 12 is capable of 6-axis motion, meaning translation along three (3) offset axes and rotation about three (3) offset axes. In particular, the drive member 12 can translate along each of a first axis x, a second axis y, and a third axis z, which three axes x, y, z are perpendicular to each other. The drive member 12 can also rotate about each of the first axis x, second axis y, and third axis z. Rotation of the drive member 12 about the first axis x can be referred to herein as “roll”; rotation about the second axis y can be referred to herein as “pitch”; and rotation about the third axis z can be referred to herein as “yaw”. In the illustrated example, the first axis x is oriented along the longitudinal direction X, the second axis y is oriented along the lateral direction Y, and the third axis z is oriented along the vertical direction Z. However, the axes x, y, z can be characterized as being anchored to the geometric center of the drive member 12. Thus, if the drive member 12 rotates, the axes x, y, z can become offset from the respective one of the longitudinal, lateral, and vertical directions X. Y, Z. The drive members 12 of the illustrated example are particularly advantageous because they can perform 6-axis movement entirely via magnetic levitation control. It should be appreciated, however, that drive members 12 utilizing other types of motion control (e.g., wheels, rollers) can also be adapted for multi-axis movement, including 6-axis movement, such as with the assistance of actuators and other control mechanisms. By using multi-axis movement (such as 6-axis movement), the drive members 12 can be controlled to perform a wide range of movements that are advantageous for performing laboratory operations on the payload 8 carried thereby. Examples of such movements and operations will be described in more detail below.

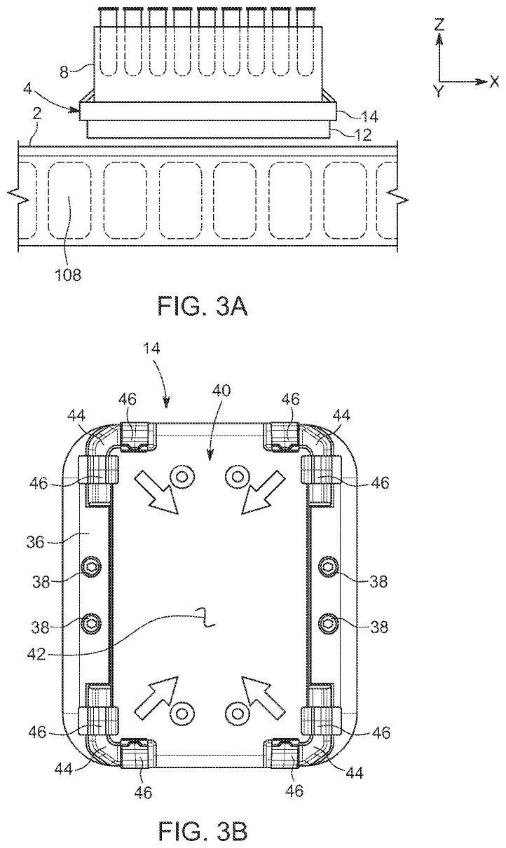

Referring now to FIG. 4, the movers 4 can be controlled to perform shaking motions. This can be achieved by causing the drive member 12 to translate in a manner that involves rapid changes in the direction(s) of translation, such as any of the longitudinal, lateral, and vertical directions X, Y, Z. Such rapid changes can occur along a single direction or multiple directions. For example, the rapid directional changes that effectuate the shaking motion(s) can involve translating the mover along tightly shaped travel paths, such as paths that are circular, elliptical, and/or involve complex or irregular shapes, which can employ curved and/or linear path segments. Shaking motions can also involve causing the drive member 12 to pitch, roll, and/or yaw. It should be appreciated that the movers 4 can be configured to perform various types of shaking motions to achieve various respective operational objections for the payload 8. For example, a mover 4 can be controllably shaken while the payload 8 thereon is being processed by a pipette or other type of processing head 105.

The shaking motion(s) can facilitate advantageous behavior for the payload 8 and/or the samples therein, such as by mixing fluids together, settling solids into place within fluid samples 7, and separating particles in fluid samples 7, by way of non-limiting examples. In this manner, the drive member 12 can be controllably shaken for effectively “stirring” or otherwise mixing fluid samples 7. The movers 4 of the illustrated embodiments (i.e., employing the magnetic levitation system described above) can exert about 20 Newtons (N) of force upon the payload. Accordingly, the acceleration at which the movers 4 can move (e.g., shake and/or stir) fluid samples 7 depends upon the mass of the payload 8 and samples therein. By way of one non-limiting example, the movers 4 can be configured to shake the payload 8 by oscillating back and forth in the X-Y plane at a frequency up to about 25 hertz. It should be appreciated that other frequencies are within the scope of the present disclosure.

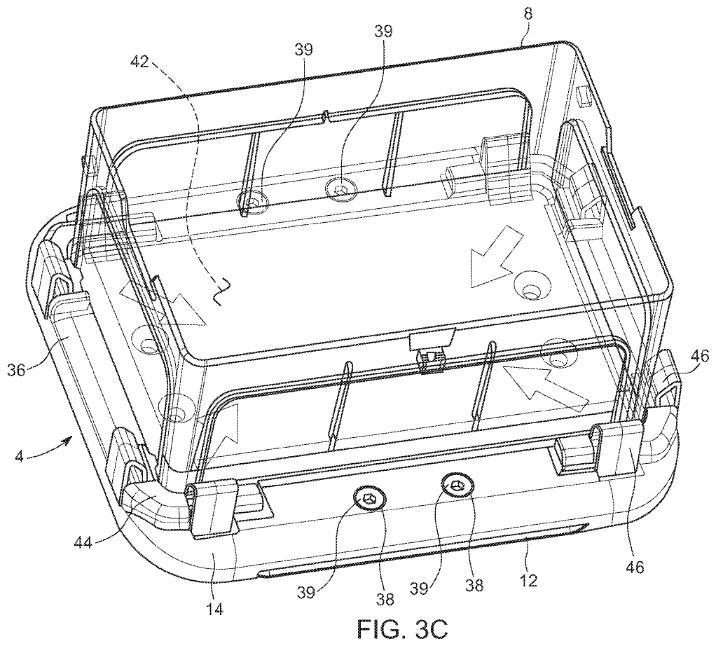

Referring now to FIG. 5, mixing and/or stirring motions can also be performed jointly with offboard components, such as a stir rod 105c. In this example, the stir rod 105c can be maintained stationary while the mover 4 is controllably moved, such as by translating in the X-Y plane in tight circles about the stir rod 105c, for example. It should be appreciated that other controlled motions for stirring and/or mixing a fluid sample can be performed by the mover 4, independently or in combination with offboard component(s).

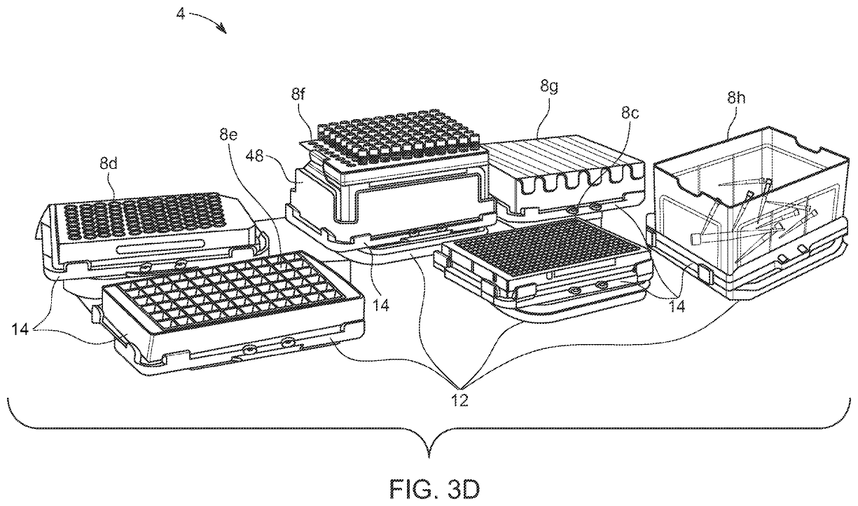

Referring now to FIG. 6, the movers 4 can be controlled to perform tilting motions. This can be achieved by causing the drive member 12 to pitch/roll about one or both of the x- and y-axes. Such tilting motions can also involve yaw about the z-axis, which can enhance the outcomes of the pitch/roll motion. In the illustrated example, the mover 4 is tilted via pitching the drive member 12 about the y-axis. The tilting motions can be employed, for example, to position fluid samples in a manner advantageous for certain lab operations. Such fluid positioning can involve causing fluid 7 to pool at a particular side or corner of a fluid vessel 8i of the payload 8, such as for targeted aspiration by an aspiration nozzle 105d, by way of a non-limiting example. In an additional or alternative example, such tilting can be employed to separate fluids, such a fluids at different stages of completion within a vessel. In the foregoing examples, the tilt angles can be adjusted as needed based upon the desired outcomes of the lab operation(s). Although the fluid vessel 8i in the illustrated example is shown as an open liquid vessel, it should be appreciated that the tilting motions can be employed with multi-vessel payloads 8, such as microtiter plates or a closed vessel with a pierceable septum for the aspiration nozzle 105d and the like. Additionally, although the processing head 105 of the illustrated example is shown as an aspiration nozzle 105d, it should be appreciated that other types of processing heads can be employed to engage fluid held by such tilted payloads, such as syringes, vacuum nozzles, and the like.

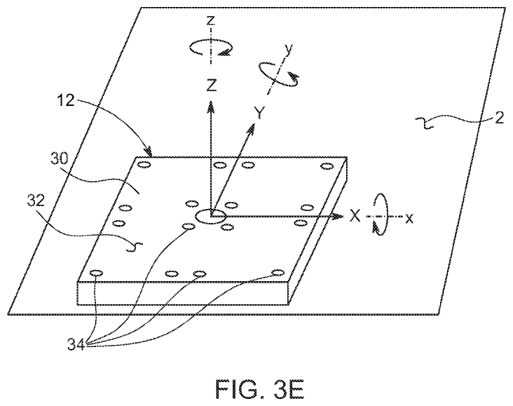

Referring now to FIG. 7, the movers 4 can be controlled to perform pitch/roll maneuvers, such as while making turns to avoid spilling fluid contents for causing other unfavorable outcomes) of the payload 8 while maintaining speed through the turn(s). In the illustrated example, the mover 4 is shown pitching about axis y at an angle A1 as the mover 4 (and its payload 8) executes a sharp turn along the working surface 2. It should be appreciated that the mover 4 can pitch/roll about multiple axes (e.g., the x- and y-axes) while the mover executes a turn. It should also be appreciated that the drive member 12 can be controlled to adjust the angle(s) of pitch/roll throughout the maneuver to increase the speed at which the mover 4 can execute the turn.

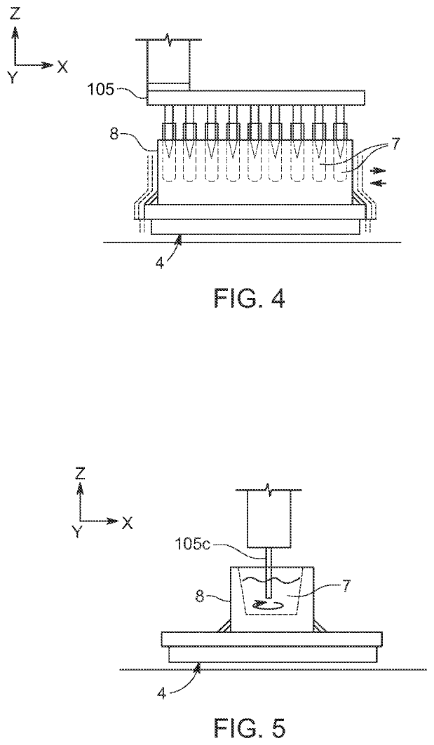

Referring now to FIG. 8, the movers 4 can be controlled to perform tapping motions. In the illustrated example, the mover 4 is controlled to perform vertical taps, which can facilitate causing fluid samples, and contents 9 therein, to move downward within a liquid vessel 7. It should be appreciated that the mover 4 can be controlled to perform lateral/longitudinal taps, or even upward taps against a processing head or other overhead offboard component.

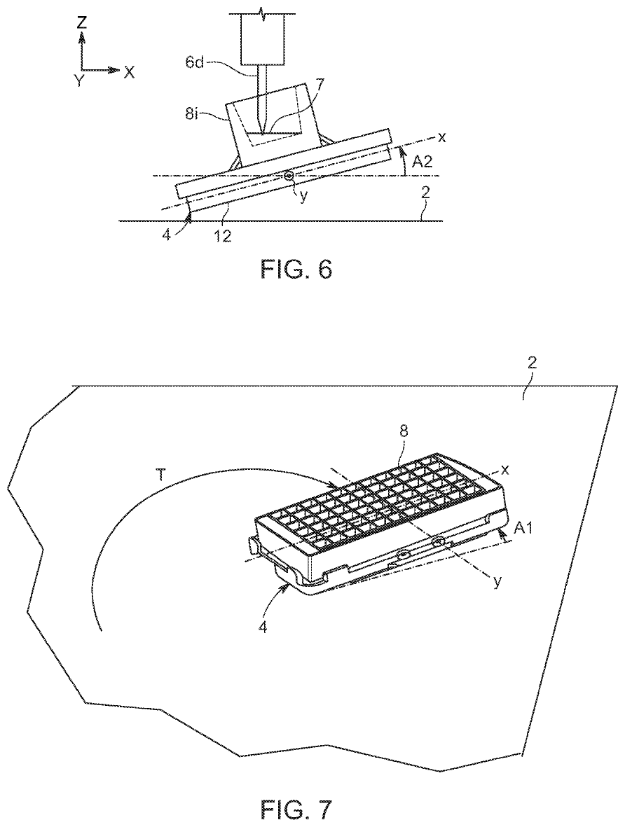

Referring now to FIG. 9, the movers 4 can be controlled to interface with another object. In the illustrated example, the mover 4 is shown interfacing with a fixed object 11 by physically pressing against the fixed object 11. For example, the mover 4 can press a portion thereof, such as a portion of the carrier 14 or of the payload 8 carried thereby, against the fixed object 11. In the illustrated example, the mover 4 is shown pressing an electrical contact 3a of the carrier 14 against a complimentary electrical contact 13b carried by the fixed object 11 for charging an onboard power source 19, such as a battery unit. In other embodiments, the mover 4 can be configured to interface with a fixed object 11 on or embedded within the working surface 2. For example, the mover 4 can be configured to position electrical contact(s) thereof (e.g., contact brushes) into contact with complimentary charging contacts on or embedded within the working surface 2. In further embodiments, the mover 4 can be configured to position an inductive receiver element of the mover 4 into charging proximity with an inductive transmitter element, such as an electromagnet, positioned on, embedded within, and/or adjacent the working surface 2, for inductive charging a power unit of the mover 4.

In additional embodiments, movers 4 can be configured to press their payload 8 against a fixed object to reposition the payload 8 relative to the mover 4. For example, in embodiments wherein the mover 4 carries a payload 8 that includes a waste container, the mover 4 can be configured to press the waste container against a fixed object in a manner that tilts the waste container to dump the contents of the waste container into a waste receptacle, such as into a waste receptacle adjacent the working surface 2. In such embodiments, interaction between the movers 4 and a fixed object can be employed to enhance waste removal efficiency by discarding the relatively limited capacity contents of payload waste containers into large capacity offboard waste container(s). In further embodiments, movers 4 can be configured to press portions thereof (or portions of their payload 8) against a fixed object in a manner that actuates fluid communication through one or more fluid ports of the payload 8, such as for liquid waste removal from a payload 8, transfer of liquid coolant to and/or from the payload 8, transfer of pneumatic fluid and/or hydraulic fluid to and/or from the payload 8, and other such fluid transfer processes.

It should be appreciated that the fixed object 11 can be temporarily, permanently, or pseudo-permanently fixed relative to the working surface 2. For example, the fixed object 11 can be a processing head that can be moved between various temporarily fixed positions relative to the working surface 2. In other embodiments, the fixed object 11 can be a post or other permanent or pseudo-permanent fixture mounted relative to the working surface 2. It should also be appreciated that the movers 4 can employ pressing actions for a wide range of other purposes and by a wide range of pressing modalities. Additional uses that employ pressing the movers 4 against another object are within the scope of the present disclosure.

In yet additional embodiments, the movers 4 can be controlled to interface with other movers 4. In such embodiments, a first mover 4 can be configured to interface with a second mover 4 to actuate an action of the first mover 4 (or vice versa). Such interfacing can include physically pressing portions of the first mover 4 and/or its payload 8 against portions of the second mover 4 and/or its payload 8, such as to activate an actuator of another mover 4 and/or its payload 8. For example, the second mover 4 can carry a push member configured to push or otherwise actuate a dump actuator for a waste container carried by the first mover 4. By way of another example, a first mover 4 can carry a payload 8 including a sensor unit (e.g., camera, scanner, thermocouple, or the like) that is configured to sense (e.g., image, scan, measure, or the like) parameters of a sample carried by the second mover 4. By way of further examples, various interactions between movers 4 can be employed such that contact or other interaction from a second mover 4 can inform or otherwise instruct action to a first mover 4. Such interactions between movers 4 can be advantageous because they can be performed independent of the locations at which offboard equipment operates with respect to the working surface 2.

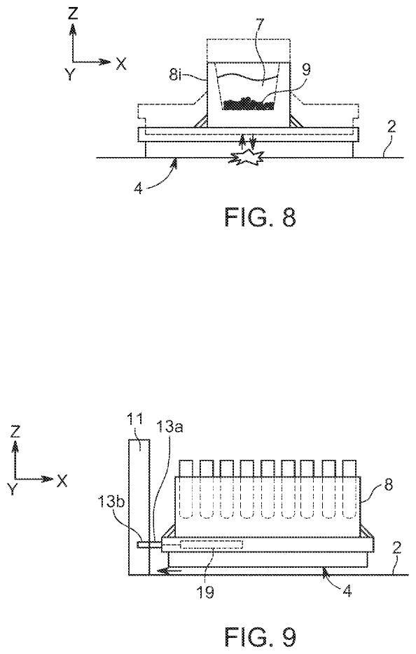

Referring now to FIG. 10, in additional embodiments, a mover 4 can include an actuatable element 21, such as heating element, a cooling element, a heating/cooling element, and the like, by way of non-limiting examples. For example, the actuatable element 21 can be heating/cooling element having a temperature range of about 4 degrees Celsius (C) to about 100 degrees C. The mover 4 according to such embodiments can be configured to employ its actuatable element 21 for affecting properties of the payload 8 or sample carried thereby. Using the example of a heating/cooling element 21, the element 21 can be actuated to raise or lower the temperature of fluid sample(s) contained in the payload 8. The heating/cooling element 21 can be a resistive element, a Peltier element, or a thermocycler, by way of non-limiting examples. Optionally, the heating element 21 can be a thermocycler that includes a heatsink coupled to a Peltier thermoelectric cooler. The actuatable element 21 can be powered by on onboard power source 19, such as a battery unit. Additionally or alternatively, the actuatable element 21 can be powered by moving the mover 4 such that electrical contact(s) carried by the mover 4 contact power delivery contacts atop, embedded within, or positioned adjacent the working surface 2, similar to the example described above with reference to FIG. 9. Additionally or alternatively, power for heating liquid samples can be delivered to the payload 8 by a processing head, such as the KingFisher® brand of processing heads discussed above.

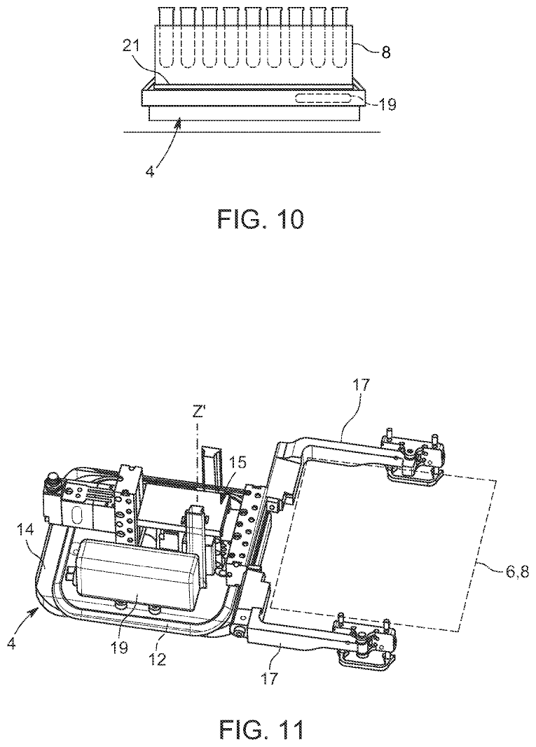

Referring now to FIG. 11, in additional embodiments, a mover 4 can be configured to carry a payload 8 that includes an actuatable lab tool. In the illustrated example, the actuatable lab tool includes a gripper 15 having controllable gripper arms 17, which can be configured to grip and manipulate (e.g., lift, rotate, tilt) various labware for additional lab operations. For example, the mover 4 and its gripper 15 can be configured to grip additional payloads 8 stored offboard and position the gripped labware atop the working surface 2, such as atop another mover 4. Similarly, mover 4 and its gripper 15 can be configured to grip a payload 8 or component(s) thereof, such as from another mover 4, and reposition the gripped payload 8 to another location atop the working surface 4, such as by placing the payload 8 onto a different mover 4, or to an offboard location, such as a labware storage area adjacent the working surface 2. For example, the mover 4 and its gripper 15 can be configured to grip payload 8, such as labware (e.g., microplates, sealed plates, and the like), from another mover 4 and/or offboard components and deposit the gripped labware into engagement with other components of the system 100, such as labware, such as centrifuges, thermocyclers, and the like, which can be located offboard or can be located onboard another mover 4. Continuing with such example, additional movers 4 can carry other labware, such as centrifuges, thermocyclers, scanners (e.g., barcode scanners, tube rack scanners), optical devices such as cameras (e.g., pan-tilt-zoom (PTZ) cameras), sensors (e.g., pH sensors), and the like. In such examples, the gripper 15 can be configured to transfer labware (e.g., microplates) to and from centrifuges, thermocyclers, and the like carried by other movers 4 or offboard components. In the illustrated example, the gripper 15 can be actuatable along a vertical gripper axis z′ to raise and lower the gripped payload 8 relative to the drive member 12 of the mover 4. In other embodiments, the gripper 15 can optionally be actuatable to rotate about the vertical gripper axis z′ relative to the drive member 12. Vertical gripper motion can be employed for various lab operations, such as for removing labware from carriers 14, to facilitate stacking labware atop each other (e.g., atop a carrier 14), for accessing offboard components, and/or accessing offboard shelving (commonly referred to as hotels or chimneys) where more labware can be stored.

The mover 4 can include an onboard power source 19, such as a battery unit, for powering the lab tool (e.g., gripper 15). Additionally or alternatively, the lab tool (e.g., gripper 15) can be powered by positioning electrical contact(s) carried by the mover 4 into engagement with power delivery contacts located atop or adjacent the working surface 2 or upon a processing head, similar to the examples described above (such as with reference to FIG. 9). It should be appreciated that the gripper 15 of the illustrated embodiment represents one of many lab tools that can be mounted to a mover for performing various lab operations. It should also be appreciated that the work deck 1 can include power delivery contacts that are powered by inductive power supply transfer and that are located at predetermined positions along the working surface 2.

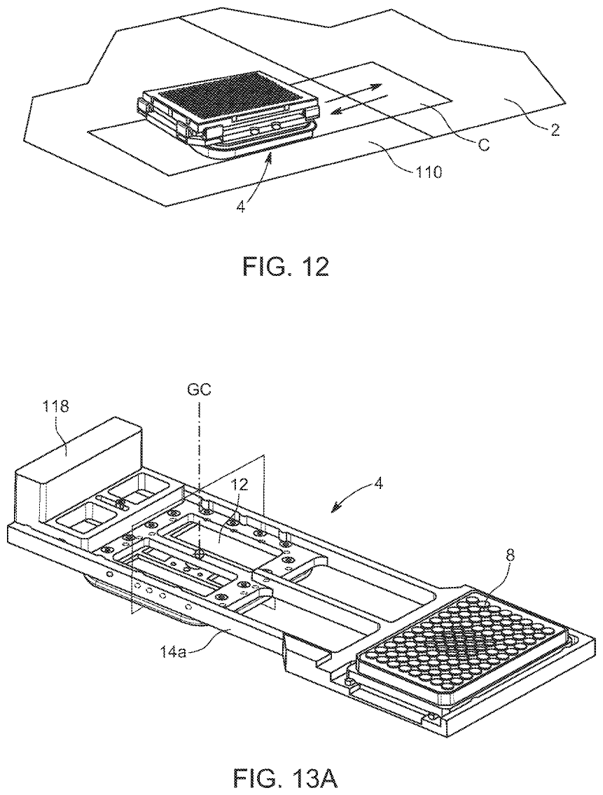

Referring now to FIG. 12, in additional embodiments, the laboratory system 100 can include an auxiliary area 110 adjacent the working surface 2. The auxiliary area 110 can be a storage area or a staging area for movers 4 when such movers 4 are not needed on the working surface 2. For the illustrated system 100, which employs the magnetic levitation system, the auxiliary area 110 can be passive. In such embodiments, the auxiliary area 110 can include a mechanism for receiving movers 4 exiting the working surface 2 and/or for delivering movers 4 to the working surface 2. One example of such a mechanism can include a conveyor C, although other mechanisms can be employed. By providing an auxiliary area 110 for unused movers 4 and/or movers 4 with payload 8 not in an immediate need of action, the traffic upon the working surface 2 can be reduced, allowing for more efficient use of the movers 4 and payload(s) 8 on the working surface 2. In this manner, the volume of laboratory operations performed by the system 100 can be increased, leading to significant time and cost savings.

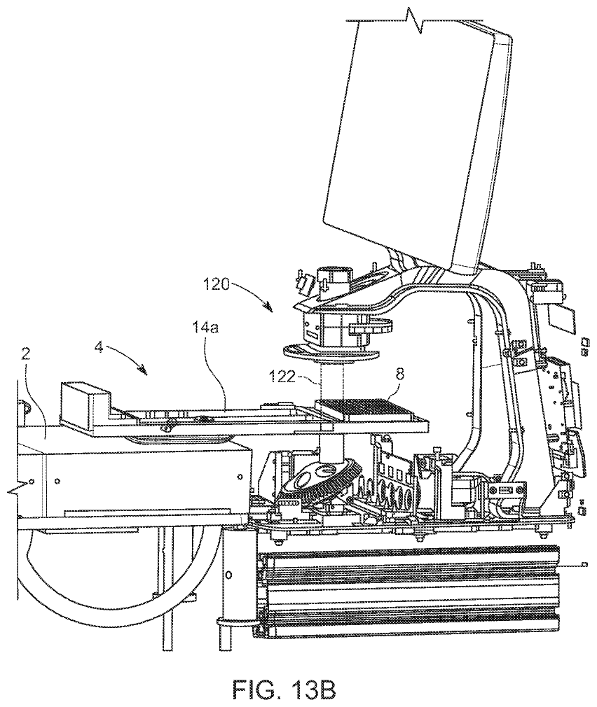

Referring now to FIGS. 13A-13B, in additional embodiments, the movers 4 can be adapted to have eccentric carriers 14a that are configured to carry payloads 8 offset from a geometric center GC of the drive member 12 in the X-Y plane. In the illustrated example, the eccentric carrier 14a is configured to carry the payload 8 so that it is entirely offset from the geometric center GC of the drive member 12. In other embodiments, eccentric carriers 14a can be configured to position a payload 8 partially offset from the geometric center GC of the drive member 12. The eccentric carrier 14a can include a counterweight 118 to maintain the payload 8 at a desired orientation relative to the working surface 2. Additionally or alternatively, the mover 4 can employ other means for maintaining an offset payload 8 at a desired orientation. For example, in embodiments employing a magnetic levitation system (such as the magnetic levitation system described above), the orientation of the offset payload 8 can be maintained or adjusted via magnetic control.

Eccentric payload 8 positioning is particularly advantageous for certain lab operations, such as those that involve positioning a payload in an engagement zone of an offboard lab tool adjacent the working surface 2, and preferably without requiring raising or lowering the payload vertically. In the illustrated example shown in FIG. 13B, the eccentric carrier 14a is shown positioning a microplate in the view field 122 of an offboard microscope 120 mounted adjacent the working surface 2. It should also be appreciated that eccentric carriers 14a can be employed for a wide variety of other lab operations, which are within the scope of the present disclosure.

It should be appreciated that the movers 4 described herein can be adapted to carry various other types of payload and to perform various other uses. For example, as described above, the movers 4 can be configured to carry waste containers (see container 8h in FIG. 3D), which can be adapted for holding solid and/or liquid waste. Additionally, the system 100 can include various types of waste deposit components into which such movers 4 can discard the waste from their waste containers 8h. For example, the waste containers 8h can be configured to include an openable side door, which can be opened in controlled fashion while positioned over a garbage chute adjacent the working surface 2. Additionally or alternatively, the mover 4 can be configured to tilt or otherwise “dump” waste from the container 8h into a garbage receptacle adjacent the working surface 2, as described above. Yet additional disposal mechanisms for use with the movers 4 are within the scope of the present disclosure.

In yet another example, a mover 4 can be configured to carry a reservoir, such as for washing various labware. For example, the mover 4 can carry payload that includes a reservoir/bucket containing cleaning solution, which can clean labware deposited within the reservoir/bucket, such as nozzle tips and the like. In such embodiments, the mover 4 can dispose of used cleaning solution, such as be discarding into a flyway or drain adjacent the working surface, such as by docking the payload 8 with fluidic transfer ports to evacuate fluid, or by a processing head which descends from above to remove fluid to discard via suction, syringe, diaphragm, or other fluid transfer means.

In yet further examples, movers 4 can be configured to interact with a wide variety of fluidic components, including fluidic dispensing devices, such as pipettes, pumps (e.g., syringe pumps, peristaltic pumps, diaphragm pumps), quick-connects for filling/draining when connected, and the like, such as for operations including, but not limited to, filling or draining a reservoir, circulating fluid through a closed loop in the carrier 14 (e.g., for temperature control), and filling or draining a fluid chamber of the carrier 14 for mass-centering.

The movers 4 described herein can provide significant advantages for performing lab operations. For example, the movers 4 and their payloads & can provide more nuanced force(s) and control of challenging lab operations. By way of non-limiting examples the movers 4 can be configured to interact with hydraulic and/or pneumatic supply components that facilitate operation of payload tools, such as grippers, manipulators, and the like. Such hydraulic and/or pneumatic payload tools can use hydraulic and/or pneumatic mediums to perform challenging operations upon various payloads, such as to squeeze or otherwise grip a plate during a seal-peeling action, or to turn a tube in a rack, or to inflate or deflate a cushion or bladder-type gripper for holding plates having irregular edge profiles in place, by way of non-limiting examples.

In additional examples, movers 4 can be configured to carry and/or interact with a wide variety of optical components, such as for microscopy, barcode scanning, IR reading, machine vision, camera imaging, visual inspection, peri-error video capture, and the like. Such optical components can be carried onboard the movers 4 or positioned offboard and can include cameras (e.g., PTZ or fixed), CMOS image sensors, or other imaging devices for visual inspection of payload and/or samples therein. The imaging devices can include stereoscopic cameras for three-dimensional imaging. The imaging devices can be configured to sense light in the visible, infrared (IR), ultra-violet (UV), or other spectrums or band detections. The imaging devices can include a laser interferometer for distance measurement, or other optical/reflection-based detection devices including acoustic distance measurement tools. The imaging operations herein can be performed via machine vision and/or to facilitate manual observation and verification. Such imaging operations can employ traditional lensing and/or microscopy. Such imaging operations can be used to read barcodes (QR or otherwise). During imaging operations, the mover 4 can be controlled to function as a focal motor and/or can be adapted to include a focus motor. It should be appreciated that other optical and imaging devices and operations are within the scope of the present disclosure.

In yet additional examples, movers 4 can be configured to interact with various additional electronic devices, such as for reading and/or identification (e.g., RFID reading), data transfer, command and control communication, and the like.

In yet other examples, movers 4 can be configured to carry and/or interact with various electro-manipulation devices, such as a cell electroporation device and/or an electrophoresis system, by way of non-limiting examples. An example of such a cell electroporation device includes one or more electrodes or electrode arrays (carried onboard the mover 4 or located offboard the mover 4) that are configured to deliver electroporative pulse(s) ex vivo to samples carried by the movers 4. An electrophoresis system of the present disclosure can include acrylamide and SDS PAGE gels, which can be employed to interrogate size and quantity of nucleic acids and proteins in samples carried by the movers 4. The nucleic acids can be mRNA, rRNA, tRNA, genomic DNA, plasmid DNA, cDNA, sheared DNA, and others. It should be appreciated that the foregoing electro-manipulation devices are provide as non-limiting examples of those that can be adapted for use with the movers 4 herein.

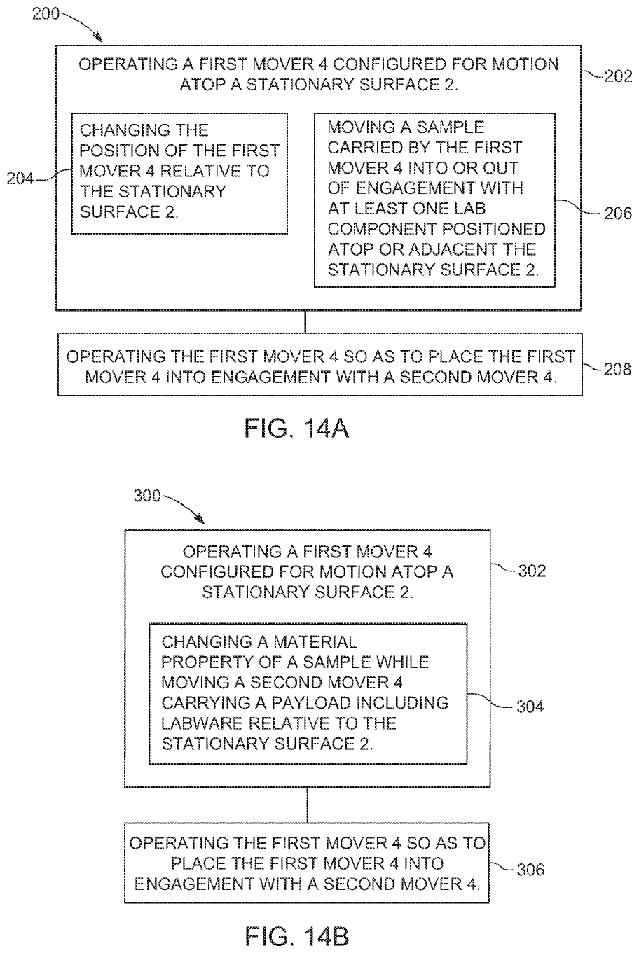

The following discussion with reference to FIGS. 14A-14B refers to example methods and steps thereof that can be performed using the features described above. Although the following steps are discussed and/or illustrated in a certain order, no particular ordering is required in these methods, unless either specifically stated or required by virtue of a step having a condition precedent upon performance of another step. It should also be appreciated that certain embodiments of the present disclosure may omit one or more of the acts described herein.

Referring now to FIG. 14A, an example flow diagram depicting steps associated with a method 200 for performing lab operations, in accordance with implementations of the present disclosure. Step 202 includes operating a first mover 4 configured for motion atop a stationary surface 2. This step 202 includes a sub-step 204 of changing the position of the first mover 4 relative to the stationary surface 2 and another sub-step 206 of moving a sample carried by the first mover 4 into or out of engagement with at least one lab component positioned atop or adjacent the stationary surface 2. Method 200 can include a step 208 of operating the first mover 4 so as to place the first mover 4 into engagement with a second mover 4. Method 200 can include various additional steps for facilitating lab operations.

Referring now to FIG. 14B, an example flow diagram depicting steps associated with another method 300 for performing lab operations, in accordance with implementations of the present disclosure. Step 302 includes operating a first mover 4 configured for motion atop a stationary surface 2. This step 302 includes a sub-step 304 of changing a material property of a sample while moving a second mover 4 carrying a payload including labware relative to the stationary surface 2. Method 300 can include a step 306 of operating the first mover 4 so as to place the first mover 4 into engagement with the second mover 4. Method 300 can include various additional steps for facilitating lab operations.

It should be appreciated that the various features, aspects, designs, parameters, and motions of the movers, labware, lab tools, and laboratory system components described above are provided as exemplary features present disclosure. These features, aspects, designs, parameters, and motions can be adjusted as needed without departing from the scope of the present disclosure.

Although the disclosure has been described in detail, it should be understood that various changes, substitutions, and alterations can be made herein without departing from the spirit and scope of the invention as defined by the appended claims. Moreover, the scope of the present disclosure is not intended to be limited to the embodiments described in the specification. One or more of the features from the foregoing embodiments can be employed in other embodiments herein. As one of ordinary skill in the art will readily appreciate from that processes, machines, manufacture, composition of matter, means, methods, or steps, presently existing or later to be developed that perform substantially the same function of achieve substantially the same result as the corresponding embodiments described herein may be utilized according to the present disclosure.

1. A system for robotic laboratory operations, the system comprising:
a stationary surface adjacent laboratory equipment;
at least one mover configured to perform an action upon a payload atop the stationary surface, wherein the at least one mover comprises:
a drive member configured to drive the translation; and
a carrier mounted to the drive member, the carrier having a top surface configured to carry the payload,
wherein the drive member is configured to drive the at least one mover across the at least the portion of the stationary surface for moving the payload relative to the laboratory equipment.

2. The system of claim 1, wherein the top surface is substantially planar.

3. The system of claim 1 or 2, wherein the action includes translation across at least a portion of the stationary surface.

4. The system of either of claim 1 or 3, wherein the action includes an up-and-down motion of the carrier.

5. The system of any one of claims 1 to 4, wherein the action includes a back-and-forth motion of the carrier.

6. The system of any one of claims 1 to 5, wherein the action includes a vertical tapping movement by which a bottom surface of the mover taps against the stationary surface.

7. The system of any one of claims 1 to 6, wherein the action includes moving the at least one mover to an auxiliary area adjacent to the stationary surface.

8. The system of any one of claims 1 to 7, wherein the action includes moving the drive member with respect to one or more of an x-axis, a y-axis, and a z-axis each defined by the at least one mover.

9. The system of claim 8, wherein the action comprises:
translating the mover along a turn, and
pitching and/or rolling the drive member about one or both of the x-axis and the y-axis.

10. The system of any one of claims 1 to 9, wherein the action includes adjusting a temperature of an element disposed on the top surface of the carrier.

11. The system of claim 10, wherein the action includes maintaining the temperature in the range of about 4 degrees C. to about 100 degrees C.

12. The system of claim 10, wherein the temperature is controlled using a resistive element.

13. The system of claim 10, wherein the temperature is controlled using a thermo-electric element.

14. The system of claim 13, wherein the thermos-electric element comprises a Peltier element.

15. The system of claim 10, wherein the temperature is controlled using a thermal cycler.

16. The system of claim 15, wherein the thermal cycler comprises a heatsink coupled to a Peltier thermoelectric cooler.

17. The system of any one of claims 1 to 16, wherein the action comprises providing electrical power to the at least one mover.

18. The system of claim 17, wherein the electrical power is provided with an inductive power supply on or adjacent stationary surface.

19. The system of claim 18, wherein the inductive power supply comprises at least one electromagnet.

20. The system of claim 18, wherein the inductive power supply comprises a plurality of contacts, wherein the plurality of contacts is located at predetermined positions in the top surface.

21. The system of any one of claims 1 to 20, wherein the action includes interacting with a second mover, the interacting optionally being performed to actuate a function.

22. The system of any one of claims 1 to 21, wherein the action includes interfacing with a fixed point located in the stationary surface to actuate a function.

23. The system of claim 22, wherein the function includes a waste removal function.

24. The system of any one of claims 1 to 23, wherein the action includes interfacing with a gripper, wherein the gripper is configured to raise or lower labware positioned in the at least one mover.

25. The system of claim 24, wherein the gripper is configured to raise or lower labware unto a second mover.

26. The system of claim 24, wherein the gripper is configured to raise or lower labware unto a fixed point.

27. The system of any one of claims 1 to 26, wherein the action comprises interfacing with a pneumatic or hydraulic device.

28. The system of any one of claims 1 to 27, wherein the action comprises interfacing with a fluidic dispensing device.

29. The system of any one of claims 1 to 29, wherein the action comprises interfacing with an optical device.

30. The system of claim 29, wherein the optical device includes a camera.

31. The system of any one of claims 1 to 30, wherein the top surface of the carrier is configured as a cell electroporation system.

32. The system of any one of claims 1 to 31, wherein the top surface of the carrier is configured as an electrophoresis system.

33. The system of any of claims 1-32, further comprising:
a processor; and
a computer readable memory configured to store computer readable instructions executable by the processor, and wherein the computer readable instructions instruct the at least one mover to perform the action.

34. A system for robotic laboratory operations, the system comprising:
a stationary surface; and
a plurality of movers each configured for motion atop the stationary surface, wherein each of the plurality of movers comprises:
a drive member configured to drive the motion; and
a carrier mounted to the drive member, the carrier having a top surface configured to carry labware components,
wherein the movers are configured to reposition labware carried by at least one of the movers relative to labware carried by at least another of the movers.

35. A method, comprising:
operating a first mover configured for motion atop a stationary surface,
the operating being performed to change the position of the first mover relative to the stationary surface,
the operating thereby moving a sample carried by the first mover into or out of engagement with labware positioned atop or adjacent the stationary surface.

36. The method of claim 35, further comprising operating the first mover to place the first mover into engagement with a second mover.

37. A method, comprising:
operating a first mover configured for motion atop a stationary surface,
the operating being performed to change a material property of a sample while moving a second mover relative to the stationary surface,
the second mover carrying labware.

38. The method of claim 37, further comprising operating the first mover to place the first mover into engagement with the second mover.
